(19) United States
(12) Patent Application Publication
(10) Pub. No.: US 2025/0115349 A1
(43) Pub. Date: Apr. 10, 2025

(54) AIRCRAFT WING WITH LEADING EDGE SPOILER

(71) Applicant: Airbus Operations Limited, FILTON (GB)

(72) Inventor: Andrea CASTRICHINI, FILTON (GB)

(21) Appl. No.: 18/905,550

(22) Filed: Oct. 3, 2024

(30) Foreign Application Priority Data
Oct. 6, 2023 (GB) 2315368.7

(51) Int. Cl. B64C 3/58

(52) U.S. Cl. CPC B64C 3/58

(57) ABSTRACT

An aircraft wing has a leading edge, a fixed wing portion and a leading-edge spoiler device. The spoiler device is hingedly mounted relative to the fixed wing portion adjacent the leading edge, moveable between retracted and deployed positions. In the retracted position a spoiler surface forms a continuous surface with a fixed wing portion upper aerodynamic surface, and in the deployed position the spoiler surface is rotated relative to the upper aerodynamic surface. In the retracted position the spoiler surface has a first portion forward of the hinge and a second portion aft of the hinge. A center of pressure of the local wing section acts on the spoiler surface providing a moment about the hinge in a first direction to bias the spoiler device to the retracted position and providing a moment about the hinge in a second, opposite direction, rotating the spoiler device to the deployed position.

### CROSS-REFERENCES TO RELATED APPLICATIONS

This application claims the benefit of Great Britain Patent Application Number 2315368.7 filed on Oct. 6, 2023, the entire disclosure of which is incorporated herein by way of reference.

### FIELD OF THE INVENTION

The present invention relates to an aircraft wing with a leading-edge spoiler and a method of operating an aircraft wing.

### BACKGROUND OF THE INVENTION

Aircraft wings may have spoilers for spoiling the lift generated by the airfoil section of the wing. The spoilers may be used for loads alleviation during high-speed cruise flight, e.g., during high g maneuvers or gusts.

### SUMMARY OF THE INVENTION

A first aspect of the invention provides an aircraft wing comprising a fixed wing portion and a leading edge spoiler device, wherein the wing has a leading edge and a trailing edge, the spoiler device is rotatably mounted relative to the fixed wing portion adjacent the wing leading edge by a hinge and is moveable between a retracted position and a deployed position; the fixed wing portion has an upper aerodynamic surface and a lower aerodynamic surface, wherein in the retracted position the spoiler device has a spoiler surface forming a continuous surface with the upper aerodynamic surface of the fixed wing portion, and in the deployed position the spoiler surface is rotated at an angle to the upper aerodynamic surface of the fixed wing portion, and wherein in the retracted position the spoiler surface has a first portion forward of the hinge and a second portion aft of the hinge.

A further aspect of the invention provides an aircraft wing comprising a fixed wing portion and a leading edge spoiler device, wherein the wing has a leading edge and a trailing edge, the spoiler device is rotatably mounted relative to the fixed wing portion adjacent the wing leading edge by a hinge and is moveable between a retracted position and a deployed position, the fixed wing portion has an upper aerodynamic surface and a lower aerodynamic surface, wherein the spoiler device has a spoiler surface forming a continuous surface with the upper aerodynamic surface of the fixed wing portion when the spoiler device is in the retracted position, and in the deployed position the spoiler surface is rotated at an angle to the upper aerodynamic surface of the fixed wing portion, wherein when a center of pressure of the local wing section acts on the spoiler surface to provide a moment about the hinge in a first direction the spoiler device is biased to the retracted position, and wherein when the center of pressure of the local wing section acts on the spoiler surface to provide a moment about the hinge in a second direction opposite the first direction then the spoiler device is operable to rotate to the deployed position.

A yet further aspect of the invention provides a method of operating an aircraft wing having a spanwise wing section with a fixed wing portion and a leading edge spoiler device rotatable about a hinge, the method comprising: moving the aircraft wing relative to a surrounding body of air with the spoiler device in a retracted position such that a spoiler surface of the spoiler device is continuous with an upper aerodynamic surface of the fixed wing portion, and a center of pressure of the local wing section acts on the spoiler device to provide a moment about the hinge to bias the spoiler device to the retracted position; and rotating the spoiler device about the hinge to a deployed position when the center of pressure of the local wing section acts on the spoiler device to provide a moment about the hinge to bias the spoiler device to the deployed position such that the spoiler surface is at an angle to the upper aerodynamic surface of the fixed wing portion so as to spoil lift generated by the aircraft wing.

A spoiler is an aerodynamic device which intentionally spoils lift created by the wing when deployed into the airflow over the wing. A primary effect of the spoiler is to reduce lift, by contrast with other aerodynamic devices such as airbrakes which have a primary effect of increasing drag when deployed, or high lift devices such as slats or flaps which have a primary effect of increasing lift when deployed.

The invention is advantageous in that the deployment of the spoiler device is dependent on the center of pressure of the local wing section (i.e., the center of pressure acting on the local spanwise portion of the wing that includes the spoiler device). The center of pressure will move either forward towards the leading edge of the wing, or aft towards the trailing edge of the wing, as the incidence (angle of attack) and/or the speed of the wing relative to the surrounding air (or freestream flow) varies. The spoiler surface may have a first portion forward of the hinge and a second portion aft of the hinge. As the center of pressure moves to act on either the first portion or the second portion, a moment may be generated about the hinge, either in a first direction or in a second direction opposite the first direction. The location of the hinge and the spoiler surface may be designed such that the change in moment about the hinge at a particular airspeed and incidence causes the spoiler to move from the retracted to the deployed position.

Preferably, when the leading-edge spoiler device is in the retracted position the aircraft wing has an airfoil profile, and when the leading edge spoiler device is in the deployed position the spoiler device extends outside of the airfoil profile to spoil lift generated by the wing.

Preferably, when in the deployed position the spoiler device extends a height outside of the airfoil profile of between 5% and 15% of the local chord length of the airfoil portion.

Preferably, when the spoiler device is in the retracted position the spoiler surface extends from the upper aerodynamic surface of the fixed wing portion to the wing leading edge.

Preferably, when the spoiler device is in the retracted position the spoiler surface extends from the upper aerodynamic surface of the fixed wing portion around the wing leading edge towards the lower aerodynamic surface of the fixed wing portion.

The hinge may be a simple hinge.

Rotation of the spoiler device from the retracted position to the deployed position may be passively controlled by forces external to the aircraft wing. These may be purely aerodynamic forces due to the pressure (e.g., the local center of pressure) acting on the wing. Alternatively, the rotation of the spoiler may be semi-passive or actively controlled, e.g., by an actuator, or a biasing element such as a spring.

Rotation of the spoiler device from the deployed position to the retracted position may be passively controlled by forces external to the aircraft wing. These may be purely aerodynamic forces due to the pressure (e.g., the local center of pressure) acting on the wing. Alternatively, the rotation of the spoiler may be semi-passive or actively controlled, e.g., by an actuator, or a biasing element such as a spring.

The first portion of the spoiler surface may be inclined forwardly away from the hinge with respect to a chord extending between the wing leading and trailing edges when the spoiler device is in the deployed position.

The spoiler device may be substantially rigid. By substantially rigid in this context is meant that the spoiler device does not appreciably deform under load on the spoiler device in normal operation.

The aircraft wing may further comprise a releasable locking mechanism arranged to prevent rotation of the spoiler device. The locking device may be selectively released, e.g., during certain operations of the aircraft wing, or certain flight phases of an aircraft to which the wing is attached.

The aircraft wing may have a wing tip end. The spoiler device may be located adjacent the wing tip end. The spoiler device may be a loads alleviation device to alleviate aerodynamic load on the wing, e.g., during a gust or high g maneuver. The wing may be a cantilevered wing. The wing root bending load is alleviated most when the load is alleviated near the wing tip end for a cantilevered wing due to the lever arm distance from the wing tip end to the root end of the wing. Therefore, it is beneficial that the spoiler device is located near the wing tip end. However, of course, the spoiler device may be located nearer the root end of the wing.

The wing tip end may have a wing tip device and the spoiler device may be located on the wing tip device. The wing tip device may be a winglet, a raked wing tip or the like. The wing tip device may be outboard of the tip end of the fixed wing portion, and therefore furthest from the wing root. Locating the spoiler device on the wing tip device may be beneficial for not only maximizing the lever arm effect of the loads alleviation but also the spoiler device may be located on a less constrained portion of the wing leading edge (e.g., outboard of integral wing fuel tanks).

The wing tip device may be a folding wing tip device. A folding wing tip device may be coupled to the fixed wing portion by a folding hinge mechanism, such that the wing span may be reduced when the aircraft is on the ground, for example, or when gust or high g loads alleviation for the wing is desirable. A passively actuating spoiler device may be especially desirable when located on a folding wing tip device so that power and control systems do not need to pass across the folding hinge mechanism.

The aircraft wing may further comprise a moveable leading edge high lift device. The spoiler device may be mounted to the moveable leading edge high lift device.

Preferably the moveable leading edge high lift device may have an active position and a stowed position, and the spoiler device may be configured to move from its retracted position only when the high lift device is in the stowed position. A high lift device, such as a flap or slat, has the function of increasing when lift when deployed. Since the spoiler device has the opposite function of decreasing (or spoiling) the lift generated by the wing, the spoiler device and the high lift device would not be deployed at the same time. However, mounting the spoiler device to the high lift device or incorporating the spoiler device into the high lift device may be beneficial when both lift spoiling and high lift functions may be required at the same spanwise section of the wing, albeit at different times.

The hinge may comprise a spring and/or damping element. The spring or damper may be used to prevent undesirable deployment or to prevent flutter of the moveable spoiler device.

The aircraft wing may comprise a plurality of the leading-edge spoiler devices spaced spanwise across the wing.

The center of pressure of the local wing section acting on the spoiler surface may vary with the incidence of the aircraft wing relative to the surrounding body of air.

The method may further comprise rotating the spoiler device about the hinge from the deployed position to the retracted position when the center of pressure of the local wing section acts on the spoiler device to provide a moment about the hinge to bias the spoiler device to the retracted position.

Rotating the spoiler device about the hinge may be passively controlled exclusively by aerodynamic forces.

Rotation of the spoiler device from the deployed position to the retracted position may be passively controlled exclusively by aerodynamic forces.

### BRIEF DESCRIPTION OF THE DRAWINGS

Embodiments of the invention will now be described with reference to the accompanying drawings, in which:

FIG. 1 shows a plan view of an aircraft having a fixed wing;

FIG. 2 shows a portion of the wing having a leading edge spoiler device;

FIG. 3A shows the spoiler device is a retracted position, and FIG. 3B shows the spoiler device in a deployed position;

FIG. 4 shows a spring/damper of the spoiler device;

FIG. 5 shows a releasable locking mechanism of the spoiler device;

FIGS. 6A-6C show the spoiler device mounted on a high lift device of the wing, with FIG. 6A showing the high lift device stowed and the spoiler device retracted, FIG. 6A shows the high lift device stowed with the spoiler device deployed, and FIG. 6C shows the high lift device in an active position with the spoiler device retracted with respect to the high lift device;

FIGS. 7A-7E show the center of pressure of the local wing section acting on the spoiler device in various configurations, with FIG. 7A showing the center of pressure aft of the hinge when the spoiler device is retracted, FIG. 7B shows the center of pressure acting at the hinge when the spoiler device is retracted, FIG. 7C shows the center of pressure acting forward of the hinge when the spoiler device ready to move from the retracted to the deployed position, FIG. 7D shows the center of pressure acting forward of the hinge when the spoiler device is deployed, and FIG. 7E shows the center of pressure acting aft of the hinge when the spoiler device is moving from the deployed to the retracted position;

FIGS. 8-10 show various shapes of spoiler device;

FIG. 11 shows a spoiler device on a folding wing tip device; and

FIG. 12 shows a plurality of spoiler devices spaced spanwise across the wing leading edge.

### DETAILED DESCRIPTION OF THE PREFERRED EMBODIMENTS

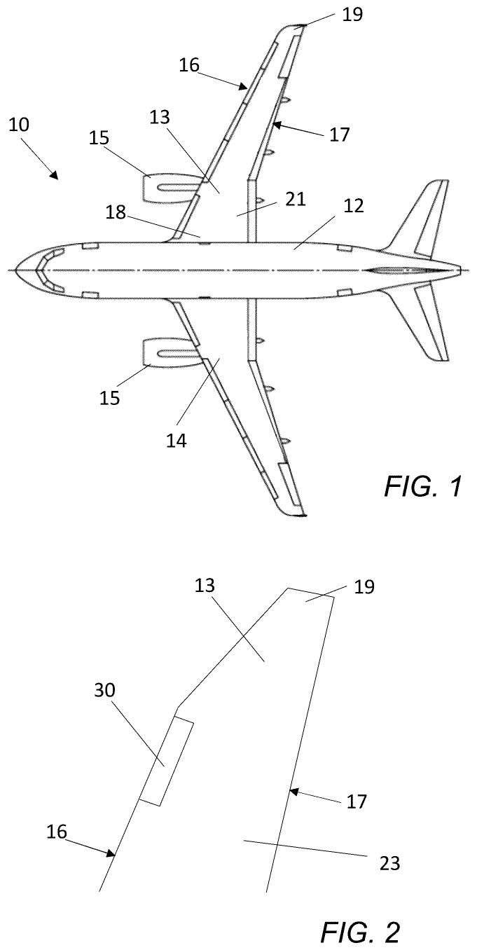

FIG. 1 shows an aircraft 10. The aircraft 10 has a fuselage 12, and starboard and port fixed wings 13, 14. An engine 15 is mounted to each wing 13, 14. The aircraft 10 is a typical jet passenger transport aircraft but the invention is applicable to a wide variety of fixed wing aircraft types, including commercial, military, passenger, cargo, jet, propeller, general aviation, etc., with any number of engines attached to the wings or fuselage. The aircraft is a fixed wing aircraft with cantilever wings.

Each wing has a cantilevered wing structure with a length extending in a spanwise direction from a root 18 to a tip 19, with the root 18 being joined to the aircraft fuselage 12. The wings 13, 14 are similar in construction and so only the starboard wing 13 will be described in detail. The wing 13 has a leading edge 16 and a trailing edge 17. The leading edge 16 is at the forward end of the wing and the trailing edge 17 is at the rearward end of the wing.

The wing has upper wing covers 21 and lower wing covers (not shown) and leading and trailing edge cover panels (collectively the “wing covers”), which form part of the outer aerodynamic surface of the wing. The wing 13 has an upper aerodynamic surface between the leading and trailing edges 16, 17 and a lower aerodynamic surface between the leading and trailing edges of the wing.

The wing 13 has a spanwise axis S which extends in a direction from the wing root 18 to the wing tip 19, and a chordwise axis which extends in the direction from the leading edge 16 to the trailing edge 17. The wing 13 has an airfoil cross section. The wing 13 has a thickness direction perpendicular to the chordwise and spanwise directions.

FIG. 2 shows a simplified representation of the wing 13 comprising a leading-edge spoiler device 30, which may be referred to hereinafter as a spoiler 30 or spoiler device 30. It is known to provide spoilers 30 for disrupting airflow over an aircraft wing to spoil or reduce the lift generated by the wing. Although shown as extending up to the leading edge 16 of the wing 13, it will be appreciated that the spoiler 30 may in some cases be positioned adjacent the leading edge 16 of the wing 13.

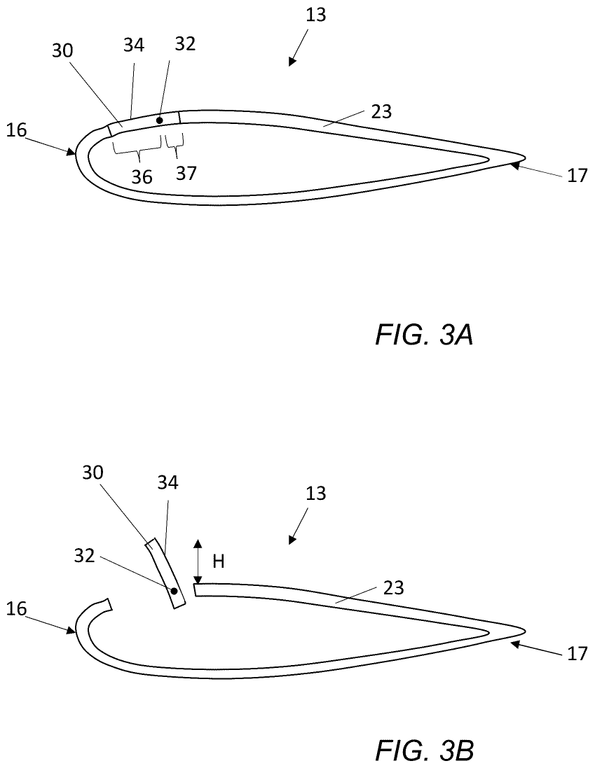

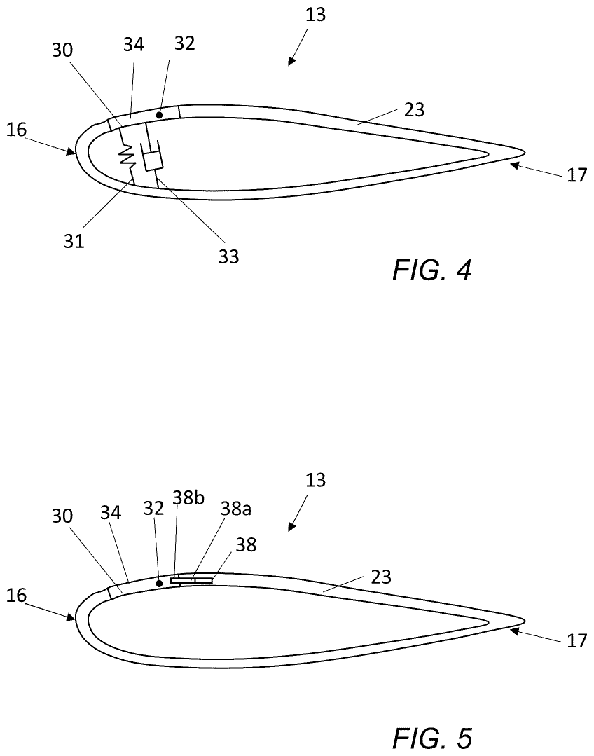

FIGS. 3a and 3b show a chordwise cross section of the wing 13 in an area adjacent the spoiler 30. The wing 13 comprises a fixed wing portion 23 which may comprise the upper wing covers 21 and lower wing covers described previously with reference to FIG. 1. The spoiler 30 is rotatably mounted to the wing 13 by a hinge 32, optionally to the fixed wing portion 23, such that the spoiler 30 is rotatable relative to the fixed wing portion 23. The hinge 32 may be a simple hinge, here defined as a hinged joint configured to permit rotation of a component attached thereto about a hinge line defined by the hinge. In some cases, the hinge 32 comprises a spring 31 and/or a damping element 33 as shown in FIG. 4 arranged to control performance of the hinge 32, for example the stiffness of the hinge joint. The spring 31 and/or the damping element 33 may be coupled to the spoiler 30 and fixed wing portion 23 as shown in FIG. 4 or may be an integral component of the hinge 32. The spoiler 30 may be substantially rigid such that it does not deform when subjected to aerodynamic loads expected during normal operating conditions. The spring or damper may be used to prevent undesirable deployment or to prevent flutter of the moveable spoiler 30.

The spoiler 30 is movable about the hinge 32 between a retracted position shown in FIG. 3a and a deployed position shown in FIG. 3b. In the retracted position, the spoiler 30 has a spoiler surface 34 which forms a continuous surface with the upper aerodynamic surface of the fixed wing profile 23. In some cases such as shown in FIG. 3a, the spoiler surface 34 and the upper aerodynamic surface of the fixed wing profile are adjacent and form a continuous surface. When the spoiler 30 is retracted, the wing 13 may have an airfoil profile as shown in FIG. 3a arranged to generate lift. In the retracted position the spoiler 30 has a first portion 36 provided forward of the hinge 32 relative to the leading edge 16 and a second portion 37 provided aft of the hinge 32. In normal cruise conditions the retracted spoiler is flush with the local aerodynamic profile geometry and does not generate any effect or local perturbation.

In the deployed position shown in FIG. 3b, the spoiler 30 is rotated such that the spoiler surface 34 is rotated at an angle relative to the upper aerodynamic surface of the fixed wing portion 23. Where the wing 13 has an airfoil profile, the spoiler 30 in the deployed position extends outside of the airfoil profile. This acts to spoil lift generated by the wing 13 by disrupting flow of air over the wing profile. The spoiler 30 may be configured to stall the local aerodynamic profile of the wing. This may result in a consequent reduction of the aircraft wing root bending loads, and/or wing bending loads and/or aircraft wing shear loads and/or aircraft wing torsion loads. The spoiler may be configured to deploy only when high wing load events occur during high speed (cruise) flight, e.g., during high g maneuvers or gusts.

When deployed, the spoiler may extend a height H outside of the airfoil profile. The height H may be between 5% and 15% of the local chord length of the airfoil portion. It may be beneficial to limit rotation of the spoiler 30 relative to the fixed wing profile 23 to prevent over-rotation of the spoiler 30. In the deployed position, the first portion 36 of the spoiler 30 may be inclined forwardly away from the hinge 32 with respect to a chord extending between the leading edge 16 and the trailing edge 17 of the wing. That is to say that the first portion 36 of the spoiler 30 is inclined at an acute angle relative to a chord of the wing 13. Preventing over-rotation of the spoiler 30 may be beneficial, in particular where retraction of the spoiler 30 from the deployed position is controlled passively as will be discussed. Alternatively, the spoiler 30 may be allowed to rotate such that the first portion 36 of the spoiler 30 is perpendicular to the chord of the wing. This may be preferably in maximizing the height H which the spoiler 30 extends outside of the wing profile.

The aircraft wing 13 may further comprise a releasable locking mechanism 38 arranged to selectively prevent rotation of the spoiler 30 relative to the fixed wing portion 23. The locking mechanism 38 may comprise a first lock portion 38a coupled to the fixed wing portion 23 and a second lock portion 38b coupled to the spoiler 30, wherein the first and second lock portions 38a, 38b are arranged to releasably connect. By way of non-limiting example, the first lock portion 38a may comprise a moveable pin and the second lock portion may comprise a bore, the pin arranged to be received in the bore. It may be particularly beneficial to prevent deployment of the spoiler 30 during certain low speed aircraft maneuvers, such as, for example, take off. The locking mechanism 38 may aid preventing unwanted rotation of the spoiler device 30.

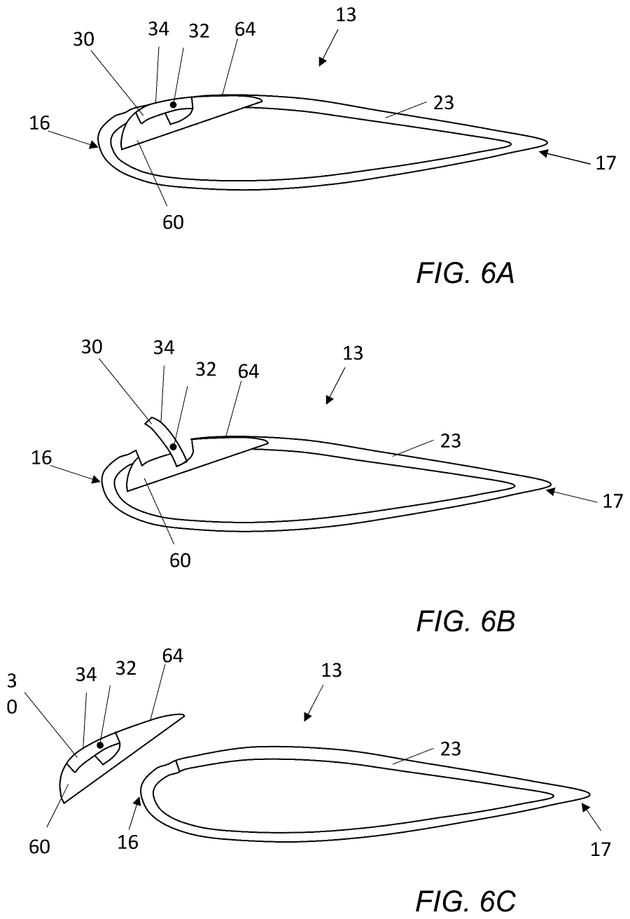

The wing 13 may further comprise a moveable leading edge high lift device, such as a slat 60, arranged to increase the lift generated by the wing 13. Any reference made hereinafter to a slat 60 may apply to any moveable leading edge high lift device. The slat 60 is moveable between a stowed position shown in FIGS. 6A and 6B and an active position shown in FIG. 6C. The slat 60 has a slat surface 64 which, when the slat 60 is stowed, forms a contiguous surface with the upper aerodynamic surface of the fixed wing portion 23 as shown in FIGS. 6A and 6B. When extended, the slat 60 acts to channel airflow over the leading edge 16 of the wing 13 to increase lift generated by the wing by increasing wing camber.

Where the wing 13 comprises a slat 60, it may be beneficial to mount the spoiler 30 to the slat 60. This may be preferable when there is limited space in the spanwise direction for mounting moveable leading-edge devices. Mounting a spoiler 30 to a slat 60 may provide a high lift device and a lift destroying device in a relatively small package. The slat 60 and the spoiler 30 may be moved between their respective housed and extended positions independent of the other.

FIG. 6A shows the spoiler 30 in its retracted position and the slat 60 in its stowed position. In this configuration, the spoiler surface 34 and the slat surface 64 form a contiguous surface such that the wing 13 has an airfoil profile for generating lift.

FIG. 6B shows the spoiler 30 in its deployed position and the slat in its stowed position. Here the spoiler 30 extends a height outside of the airfoil profile to disrupt air flow over the wing 13 and spoil lift.

Finally, FIG. 6C shows the spoiler 30 in its retracted position and the slat 60 in its active position. Here the slat 60 channels air flow over the leading edge 16 of the wing 13 to increase the lift generated. Again, the spoiler surface 34 and the slat surface 64 form a contiguous surface such that lift generated by the wing 13 is not spoiled.

It is preferable to configure the spoiler 30 to move from its retracted position only when the slat 60 is in its stowed position, as extending both devices simultaneously would provide little benefit for generating or spoiling lift.

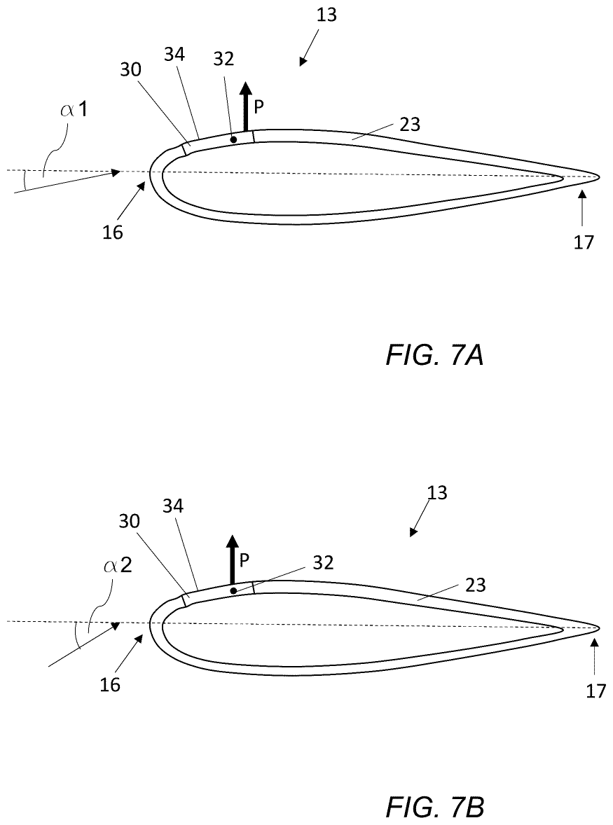

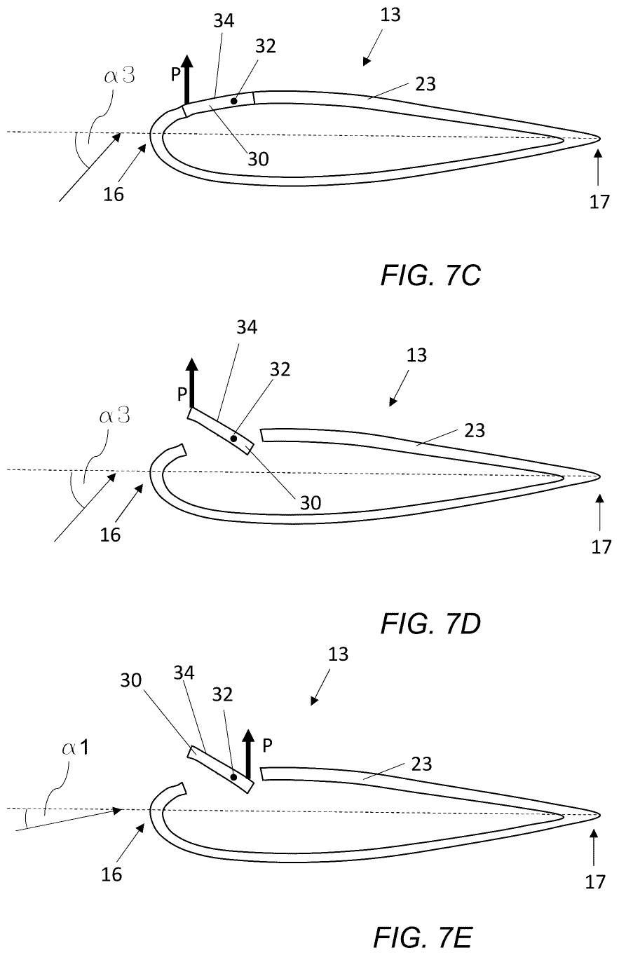

FIGS. 7A to 7E show the aircraft wing 13 of FIGS. 3 and 4 moving relative to a surrounding body of air. Deployment and retraction of the spoiler 30 may be passively controlled by forces external to the wing 13, optionally by aerodynamic forces resulting from movement of the wing 13 relative to a surrounding body of air. A method of passively controlling the deployment and retraction of the spoiler 30 will now be described with reference to FIGS. 7A to 7E.

FIG. 7A shows the wing 13 inclined at a first angle of attack a1 (defined between an oncoming flow or air and the chord of the wing 13 extending from the leading edge 16 to the trailing edge 17) and with the spoiler 30 in the retracted position. The angle of attack a may be referred to as an angle of incidence. The local pressure acting on different areas of the wing 13 will vary as a result of air flowing over the wing 13. These pressures determine the aerodynamic force acting on the wing 13. The aerodynamic force acting over the entirety of the wing 13 may be considered as a single force acting through the average location of the pressure on the surface of the wing 13. This average location is known as the center of pressure. The center of pressure may be calculated over a spanwise wing section or over a local wing section. The center of pressure depends on the angle of attack of the wing 13—increasing the angle of attack will result in the center of pressure moving forwards towards the leading edge 16 of the wing 13.

FIG. 7A shows the wing 13 inclined at an angle of attack a1 such that the center of pressure P acts on the spoiler 30 to provide a moment about the hinge 32 to bias the spoiler 30 to its retracted position. In the illustrated example, the center of pressure P acts on the second portion 37 of the spoiler 30 where rotation of the spoiler 30 in an anti-clockwise direction is prevented, optionally by the spoiler 30 engaging with the fixed wing portion 23. In the normal cruise condition, the local aerodynamic center of pressure P is located behind the spoiler hinge thus keeping the device undeployed when is not needed.

As the angle of attack is increased to second angle of attack a2 as shown in FIG. 7B (i.e., a2 is greater than a1) the center of pressure P moves forward. At an angle of attack a2 the center of pressure acts in line with the hinge 32, and hence does not apply a moment to the spoiler 30 since the moment arm is zero. The center of pressure P acting in line with the hinge 32 and the corresponding angle of attack a2 may be considered threshold conditions.

As the angle of attack is increased to a third angle of attack a3 as shown in FIG. 7C (i.e., a3 is greater than a2) the center of pressure P moves forward of the hinge 32 towards the wing leading edge. In this case the center of pressure P acts on the spoiler 30 to provide a moment about the hinge 32 to bias the spoiler 30 to its deployed position. This will result in a pitch up aerodynamic moment around the hinge causing the spoiler to rotate upward thus leading to a local flow separation and consequent flow reduction. The spoiler 30 is rotated to the deployed position as long as the angle of attack stays above a given threshold.

FIG. 7D shows the spoiler 30 in its deployed position with the angle of attack of the wing 13 maintained at a3. In this condition the center of pressure P still acts forward of the hinge 32 which may be used to bias the spoiler to maintain its deployed position. In this way deployment of the spoiler 30 is passively controlled by forces external to the wing 13, which may be beneficial for example in reducing the mass and complexity of the spoiler 30 compared to a spoiler comprising a motor or other actuator for actively actuating the spoiler.

When deployed, the spoiler 30 is configured to provide a significant lift reduction on the local aerodynamic section of the wing, leading to a significant loads reduction on the wing (e.g., a reduction in the wing bending moment, or shear or torsion loads), to counter the high g maneuver or gust loads which precipitated the increase in angle of attack.

FIG. 7E shows a wing 13 with the spoiler 30 in the deployed position and the angle of attack reduced to the first angle of attack a1. In this state, the center of pressure acts on the second portion 37 of the spoiler 30 to bias the spoiler to its retracted position. The aerodynamic flow will now generate a pitch down moment with respect to the hinge causing the spoiler 30 to rotate back down. In the illustrated example this would result in the spoiler 30 being biased to rotate in an anti-clockwise direction. As such, retraction of the spoiler 30 may also be passively controlled by forces external to the wing 13. The spoiler 30 may be configured to automatically retract as soon as the high loads event is finished. Once fully retracted, the spoiler 30 once again has no impact on the aerodynamic performance of the wing.

Rotation of the spoiler device from the retracted position to the deployed position may be purely passively controlled by the forces external to the aircraft wing. These may be purely aerodynamic forces due to the pressure (e.g., the local center of pressure) acting on the wing. By purely passive it is meant that there is no actuator for moving the spoiler 30. Passive deployment may provide a spoiler capable of self-actuating for higher values of angle of attack of the wing during cruise (high speed) flight. Alternatively, the rotation of the spoiler may be semi-passive (i.e., with an actuator for assistance above the aerodynamic forces external to the spoiler) or actively controlled, e.g., by an actuator, or a biasing element such as a spring.

Rotation of the spoiler device from the deployed position to the retracted position may also be passively controlled by forces external to the aircraft wing. These may be purely aerodynamic forces due to the pressure (e.g., the local center of pressure) acting on the wing. Passive retraction may provide a spoiler capable of self-retraction when the angle of attack of the wing returns to ‘normal’ cruise attitude. Alternatively, the rotation of the spoiler may be semi-passive or actively controlled, e.g., by an actuator, or a biasing element such as a spring.

Purely passive operation of the spoiler may be desirable as this may carry the advantage of low weight and low probability of failure due to the lack of an actuator.

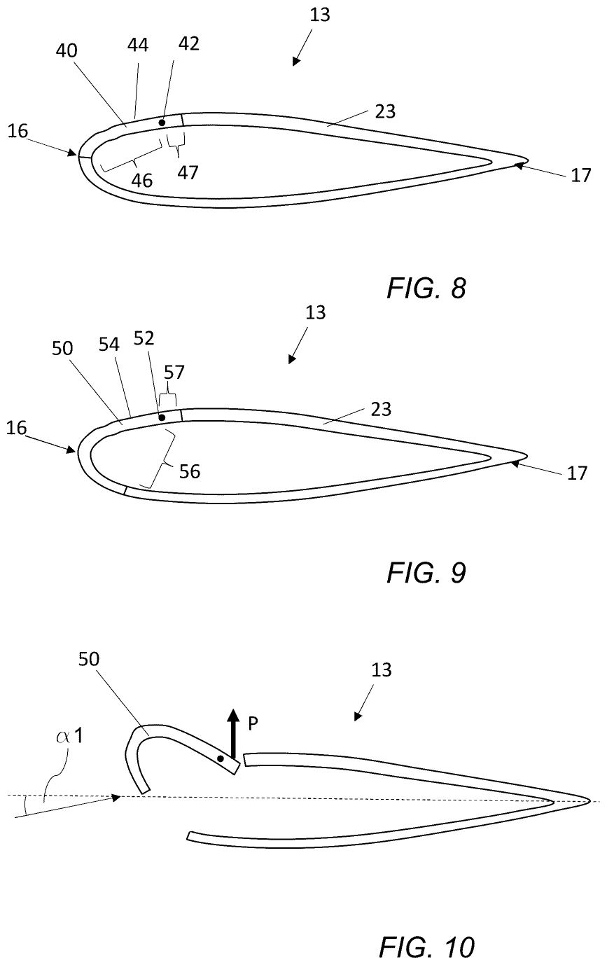

FIGS. 8 and 9 show wings 13 comprising a second embodiment of the spoiler 40 and a third embodiment of the spoiler 50 respectively. As shown in FIG. 8, in its retracted position the second embodiment of the spoiler 40 comprises a spoiler surface 44 which extends from the upper aerodynamic surface of the fixed wing region 23 to the wing leading edge 16. As shown in FIG. 9, in its retracted position the third embodiment of the spoiler 50 comprises a spoiler surface 54 which extends from the upper aerodynamic surface of the fixed wing region 23 around the wing leading edge 16 towards the lower aerodynamic surface of the fixed wing portion 23. As such, each of the second and third embodiments of the spoiler 40, 50 may be referred to as an extended spoiler 40, 50 in comparison to the spoiler 30. Each spoiler 40, 50 is rotatably mounted about a hinge 42, 52 and comprises a first portion 46, 56 forward of the hinge and a second portion 47, 57 aft of the hinge.

Providing an extended spoiler 40, 50 may improve the ease of passively controlling retraction of the spoiler. FIG. 10 shows a wing 13 comprising the third embodiment of the spoiler 50, however it will be appreciated that the following description may also apply to a wing 13 comprising the second embodiment of the spoiler 40. The wing 13 is inclined at a first angle of attack a1 such that the center of pressure P is acting on a second portion 57 of the spoiler 50 as previously described with reference to FIG. 7A. The spoiler 50 is in the deployed position.

In addition to the center of pressure P acting to bias the spoiler 50 to its retracted position, the flow of air impacting upon the spoiler surface 54 may provide a further force to bias the spoiler 50 to its retracted position.

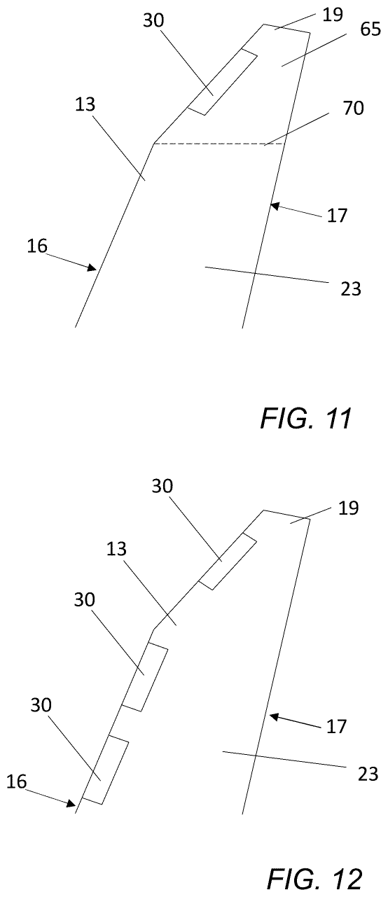

The wing 13 may have a wing tip device 65. The wing tip device 65 may be a raked wing tip, a winglet or the like. The spoiler 30 may be mounted on the wing tip device, as shown in FIG. 11. The wing tip device may be a fixed wing tip device that is rigidly coupled to the fixed wing portion 23 of the wing 13. Optionally, the wing tip device 65 may be a folding wing tip device rotatable about a folding hinge 70 with respect to the fixed wing portion 23 of the wing 13.

The folding wing tip device may be coupled to the fixed wing portion by a folding hinge mechanism, such that the wing span may be reduced when the aircraft 10 is on the ground, for example, or when gust or high g loads alleviation for the wing 13 is desirable. A passively actuating spoiler device 30 may be especially desirable when located on a folding wing tip device so that power and control systems do not need to pass across the folding hinge mechanism.

The aircraft wing 13 may comprise a plurality of the leading-edge spoiler devices 30 spaced spanwise across the wing 13, as shown in FIG. 12. The spoiler devices 30 may be all located on the fixed wing portion 23, or one or more of the spoiler devices may be located on a wing tip device 65 of the wing.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft wing comprising:
a fixed wing portion, and
a leading-edge spoiler device,
wherein the aircraft wing has a leading edge and a trailing edge,
the spoiler device is rotatably mounted relative to the fixed wing portion adjacent the wing leading edge by a hinge and is moveable between a retracted position and a deployed position;
the fixed wing portion has an upper aerodynamic surface and a lower aerodynamic surface,
wherein in the retracted position, the spoiler device has a spoiler surface forming a continuous surface with the upper aerodynamic surface of the fixed wing portion, and in the deployed position, the spoiler surface is rotated at an angle to the upper aerodynamic surface of the fixed wing portion, and
wherein in the retracted position, the spoiler surface has a first portion forward of the hinge and a second portion aft of the hinge.

2. The aircraft wing according to claim 1,
wherein when the leading edge spoiler device is in the retracted position the aircraft wing has an airfoil profile, and
wherein when the leading edge spoiler device is in the deployed position the spoiler device extends outside of the airfoil profile to spoil lift generated by the wing.

3. The aircraft wing according to claim 1, wherein when in the deployed position the spoiler device extends a height outside of the airfoil profile of between 5% and 15% of a local chord length of the airfoil portion.

4. The aircraft wing according to claim 1, wherein when the spoiler device is in the retracted position the spoiler surface extends from the upper aerodynamic surface of the fixed wing portion to the wing leading edge.

5. The aircraft wing according to claim 1, wherein when the spoiler device is in the retracted position the spoiler surface extends from the upper aerodynamic surface of the fixed wing portion around the wing leading edge towards the lower aerodynamic surface of the fixed wing portion.

6. The aircraft wing according to claim 1, wherein the hinge is a simple hinge.

7. The aircraft wing according to claim 1,
wherein rotation of the spoiler device from the retracted position to the deployed position is passively controlled by forces external to the aircraft wing, and
wherein rotation of the spoiler device from the deployed position to the retracted position is passively controlled by forces external to the aircraft wing.

8. The aircraft wing according to claim 1, wherein the first portion of the spoiler surface is inclined forwardly away from the hinge with respect to a chord extending between the wing leading and trailing edges when the spoiler device is in the deployed position.

9. The aircraft wing according to claim 1, wherein the spoiler device is substantially rigid.

10. The aircraft wing according to claim 1, further comprising a releasable locking mechanism configured to prevent rotation of the spoiler device.

11. The aircraft wing according to claim 1,
wherein the aircraft wing has a wing tip end,
wherein the spoiler device is located adjacent the wing tip end,
wherein the wing tip end has a wing tip device and the spoiler device is located on the wing tip device, and
wherein the wing tip device is a folding wing tip device.

12. The aircraft wing according to claim 1,
wherein the aircraft wing further comprises a moveable leading edge high lift device,
wherein the spoiler device is mounted to the moveable leading edge high lift device, and
wherein the moveable leading edge high lift device has an active position and a stowed position, and the spoiler device is configured to move from its retracted position only when the high lift device is in the stowed position.

13. The aircraft wing according to claim 1, wherein the hinge comprises at least one of a spring or a damping element.

14. The aircraft wing according to claim 1, comprising a plurality of the leading-edge spoiler devices spaced spanwise across the wing.

15. A method of operating an aircraft wing having a spanwise wing section with a fixed wing portion and a leading-edge spoiler device rotatable about a hinge, the method comprising:
moving the aircraft wing relative to a surrounding body of air with the spoiler device in a retracted position such that a spoiler surface of the spoiler device is continuous with an upper aerodynamic surface of the fixed wing portion, and a center of pressure of a local wing section acts on the spoiler device to provide a moment about the hinge to bias the spoiler device to the retracted position; and
rotating the spoiler device about the hinge to a deployed position when the center of pressure of the local wing section acts on the spoiler device to provide a moment about the hinge to bias the spoiler device to the deployed position such that the spoiler surface is at an angle to the upper aerodynamic surface of the fixed wing portion so as to spoil lift generated by the aircraft wing.

16. The method of claim 15, wherein the center of pressure of the local wing section acting on the spoiler surface varies with an incidence of the aircraft wing relative to the surrounding body of air.

17. The method of claim 15, further comprising rotating the spoiler device about the hinge from the deployed position to the retracted position when the center of pressure of the local wing section acts on the spoiler device to provide a moment about the hinge to bias the spoiler device to the retracted position.

18. The method of claim 15,
wherein rotating of the spoiler device about the hinge is passively controlled exclusively by aerodynamic forces, and
wherein rotation of the spoiler device from the deployed position to the retracted position is passively controlled exclusively by aerodynamic forces.

19. An aircraft wing comprising:
a fixed wing portion, and
a leading-edge spoiler device,
wherein the aircraft wing has a leading edge and a trailing edge,
the spoiler device is rotatably mounted relative to the fixed wing portion adjacent the wing leading edge by a hinge and is moveable between a retracted position and a deployed position,
the fixed wing portion has an upper aerodynamic surface and a lower aerodynamic surface,
wherein the spoiler device has a spoiler surface forming a continuous surface with the upper aerodynamic surface of the fixed wing portion when the spoiler device is in the retracted position, and in the deployed position the spoiler surface is rotated at an angle to the upper aerodynamic surface of the fixed wing portion,
wherein when a center of pressure of a local wing section acts on the spoiler surface to provide a moment about the hinge in a first direction the spoiler device is biased to the retracted position, and
wherein when the center of pressure of the local wing section acts on the spoiler surface to provide a moment about the hinge in a second direction opposite the first direction then the spoiler device is operable to rotate to the deployed position.
